(19) United States
(12) Patent Application Publication
(10) Pub. No.: US 2004/0121222 A1
(43) Pub. Date: Jun. 24, 2004

(54) Crack-resistant anode-supported fuel cell

(76) Inventors: Partho Sarkar, Edmonton (CA); Hongsang Rho, Edmonton (CA)

Correspondence Address: GRAYBEAL, JACKSON, HALEY LLP, 155 - 108TH AVENUE NE, SUITE 350, BELLEVUE, WA, 98004-5901, US

(21) Appl. No.: 10/658,803

(22) Filed: Sep. 9, 2003

Related U.S. Application Data
(60) Provisional application No. 60/409,194, filed on Sep. 10, 2002.

(51) Int. Cl. H01M 4/86; H01M 4/90; H01M 8/12

(52) U.S. Cl. 429/45; 429/30

(57) ABSTRACT

This invention relates to an anode-supported solid oxide fuel cell that is resistant to volume-change-induced cracking. The fuel cell has an anode support layer comprising a porous ion conducting structure impregnated with nickel-containing material. The ion-conducting structure may be composed of yttria-stabilized zirconia. The nickel-containing material is impregnated in the pores of the ion conducting structure such that any expansion in volume associated with the oxidation of Ni to NiO occurs substantially within the pores of the anode support layer, thereby minimizing any volume expansion of the anode support layer.

### PRIORITY CLAIM

This application claims priority from U.S. provisional patent application No. 60/409,194, filed Sep. 10, 2002, which is incorporated herein by reference.

### FIELD OF THE INVENTION

This invention relates generally to fuel cells, and in particular to anode-supported solid oxide fuel cells.

### BACKGROUND OF THE INVENTION

In general, a solid oxide fuel cell (SOFC) comprises a pair of electrodes (anode and cathode) separated by a ceramic, solid-phase electrolyte. To achieve adequate ionic conductivity in such a ceramic electrolyte, the SOFC operates at an elevated temperature, typically in the order of between 700-1000° C. The material in typical SOFC electrolytes is a fully dense (i.e. non-porous) yttria-stabilized zirconia (YSZ) which is an excellent conductor of negatively charged oxygen (oxide) ions at high temperatures. Typical SOFC anodes are made from a porous nickel/zirconia cermet while typical cathodes are made from magnesium doped lanthanum manganate (LaMnO₃), or a strontium doped lanthanum manganate (also known as lanthanum strontium manganate (LSM)). In operation, hydrogen or carbon monoxide (CO) in a fuel stream passing over the anode reacts with oxide ions conducted through the electrolyte to produce water and/or CO₂ and electrons. The electrons pass from the anode to outside the fuel cell via an external circuit, through a load on the circuit, and back to the cathode where oxygen from an air stream receives the electrons and is converted into oxide ions which are injected into the electrolyte. The SOFC reactions that occur include:

Anode reaction: H₂+O^{═}→H₂O+2e⁻

CO+O^{═}→CO₂+2e⁻

CH₄+4O^{═}→2H₂O+CO₂+8e⁻

Cathode reaction: O₂+4e⁻→2O^{═}

Known SOFC designs include electrolyte-supported and anode-supported fuel cells. Electrolyte-supported designs have a thick electrolyte layer with thin anode and cathode layers; the electrolyte layer provides mechanical support for the fuel cell. In contrast, anode-supported designs have an anode layer that acts as the supporting structure. The anode composition is a solid state porous nickel/zirconia cermet wherein the nickel may be in metallic (Ni) or oxide (NiO) form or a mixture of both. The anode-supported SOFC is typically sandwiched or held between metal-interconnecting plates that act as air and gas flow plates as well as the electrical connection between each cell.

One problem found in existing anode-supported SOFC designs is cracking of the electrolyte layer that results from volume changes in the anode support layer. The volume changes of the anode support layer introduce stress in the electrolyte layer which cause the electrolyte to crack. It is theorized that the volume changes are caused primarily by oxidation-reduction reactions of the Ni/NiO in the anode support layer, which may occur, for example, when the fuel cell is suffering from fuel starvation. Since NiO has a lower density (6.72 g/cm³) than Ni (8.9 g/cm³), there is a volume increase in the anode layer when the Ni is oxidized and a corresponding volume decrease when NiO is reduced. Volume changes may also be caused by temperature changes in the anode support layer.

It is therefore desired to provide a solution to reduce or eliminate altogether the occurrence of volume-change-induced cracking in an anode-supported SOFC.

### SUMMARY

According to one aspect of the invention, there is provided an anode-supported solid oxide fuel cell comprising: an anode support layer comprising a porous ion-conducting structure having pores impregnated with nickel-containing material or other catalytic and electronically conductive materials such as Cu and its alloys, Ag and its alloys (e.g., Ag—Ni alloy), tungsten and its alloys; an electrolyte layer in adjacent intimate contact with the anode support layer; and a cathode layer in adjacent intimate contact with the electrolyte layer. The fuel cell may further comprise an anode functional layer between and in adjacent intimate contact with the anode support layer and the electrolyte layer.

The composition of the porous ion-conducting structure of the anode support layer may be substantially yttria-stabilized zirconia (YSZ). The catalytic and electronically conductive material may be substantially evenly distributed throughout the anode support layer. Alternatively, the catalytic and electronically conductive material may be compositionally graded through the thickness of the anode support layer, with a higher concentration of the catalytic and electronically conductive material at one major surface of the anode support layer than the other. In a graded case wherein the catalytic and electronically conductive material is nickel-containing material, the anode support layer may further comprise a second conductive metal selected from the group of ferritic steel, super alloy, and Ni—Ag alloy, which is concentrated at the major surface of the anode support layer having the lower concentration of the Ni-containing material.

The fuel cell may further include a porous zirconia-nickel cermet buffer layer sandwiched in between the anode support layer and anode functional layer, and having a porosity between 40-90%. Instead of being substantially YSZ, the composition of the porous ion conducting structure may be a mixture of 10-30% Ni, NiO or both, and the balance being yttria-stabilized zirconia (YSZ). Further, the anode support layer may further comprise a plurality of vias extending through the thickness of the ion conducting structure, wherein the vias are filled with an electronically conducting material.

### BRIEF DESCRIPTION OF THE DRAWINGS

FIG. 1 is a schematic elevation view of an anode supported fuel cell having a Nickel-impregnated anode layer.

FIG. 2 is a schematic elevation view of an anode supported fuel cell having a plurality of vias filled with electronically conductive material in the anode layer.

FIG. 3 is a schematic elevation view of an anode supported fuel cell having a compositiontally graded anode layer.

FIG. 4 is a schematic elevation view of an anode supported fuel cell having a highly porous buffer layer in between an anode support layer and an anode functional layer.

FIG. 5 is a graph of thermal expansion coefficient vs. vol. % of Ni or NiO cermet.

### DETAILED DESCRIPTION

When describing the present invention, the following terms have the following meanings, unless indicated otherwise. All terms not defined herein have their common art-recognized meanings.

The term “ceramic” refers to inorganic non-metallic solid materials with a prevalent covalent or ionic bond including, but not limited to metallic oxides (such as oxides of aluminum, silicon, magnesium, zirconium, titanium, chromium, lanthanum, hafnium, yttrium and mixtures thereof) and nonoxide compounds including but not limited to carbides (such as of titanium tungsten, boron, silicon), suicides (such as molybdenum disicilicide), nitrides (such as of boron, aluminum, titanium, silicon) and borides (such as of tungsten, titanium, uranium) and mixtures thereof; spinels, titanates (such as barium titanate, lead titanate, lead zirconium titanates, strontium titanate, iron titanate), ceramic super conductors, zeolites, and ceramic solid ionic conductors (such as yittria stabilized zirconia, beta-alumina and cerates).

The term “cermet” refers to a composite material comprising a ceramic in combination with a metal, typically but not necessarily a sintered metal, and typically exhibiting a high resistance to temperature, corrosion, and abrasion.

The term “porous” in the context of hollow ceramic, metal, and cermet membranes means that the ceramic material contains pores (voids). Therefore, the density of the porous membrane material is lower than that of the theoretical density of the material. The voids in the porous membranes can be connected (i.e., channel type) or disconnected (i.e. isolated). In a porous hollow membrane, the majority of the pores are connected. To be considered porous as used herein in reference to membranes, a membrane should have a density which is at most about 95% of the theoretical density of the material. The amount of porosity can be determined by measuring the bulk density of the porous body and from the theoretical density of the materials in the porous body. Pore size and its distribution in a porous body can be measured by mercury or non-mercury porosimeters, BET or microstructural image analysis as is well known in the art.

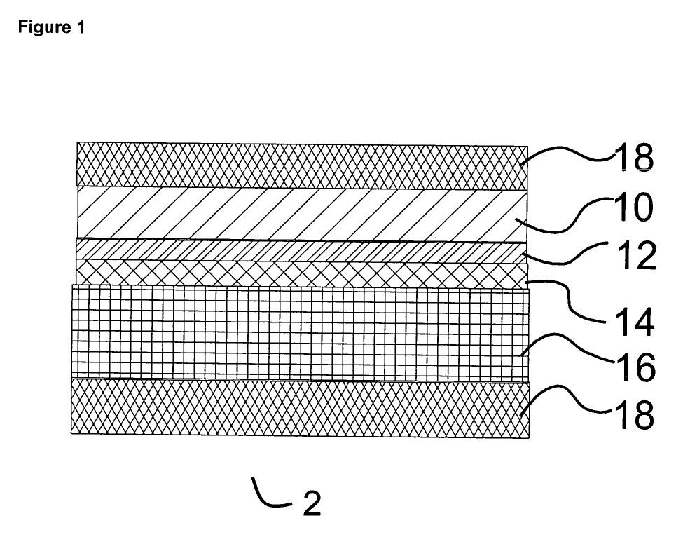

Referring to FIG. 1 and according to a first embodiment of the invention, a planar anode-supported fuel cell 2 is shown having a number of layers in contiguous intimate contact, namely: a cathode layer 10, an electrolyte layer 12, an anode functional layer 14 (AFL), an anode support layer 16 (ASL), and a pair of metallic current collectors 18 sandwiching these layers 10, 12, 14, 16. While a planar fuel cell 2 is shown in this and other described embodiments, it is to be understood that this invention applies to different geometric configuration of fuel cells, e.g. tubular fuel cells. The current collectors 18 can be electrically coupled to an external circuit (not shown) to transmit electrons produced during the electrochemical reaction.

In this embodiment, the cathode layer 10 has a thickness of between 2-50 μm, the electrolyte layer 12 has a thickness between 2-25 μm, the anode functional layer 14 (AFL) has a thickness between 1-20 μm, and is typically around 5 μm, and the anode support layer (ASL) 16 has a suitable thickness of 100 μm to 2000 μm. However, the ASL 16 may be thinner depending on the SOFC design, e.g. in a small diameter (<5 mm) tubular SOFC.

The cathode layer 10 is composed of magnesium doped lanthanum manganate (LaMnO₃), or a lanthanum strontium manganate (LSM) as is well known in the art. Also, the electrolyte layer 12 is made of a fully dense (i.e. non-porous) yttria-stabilized zirconia (YSZ) which is an excellent conductor of negatively charged oxygen (oxide) ions at high temperatures. The anode functional layer 14 is composed of porous nickel/zirconia cermet material.

The ASL 16 is composed of a solid state yttria-stabilized zirconia (YSZ) structure impregnated with Ni or Ni-containing compounds. Alternatively, other catalytic and electrically conductive materials, as is known in the art, may be substituted for the Ni or Ni-containing compounds. Also alternatively, other oxygen ion conducting materials suitable for SOFC use and having a relatively similar thermal coefficient to the electrolyte, as is known in the art, may be substituted for YSZ. The ASL 16 is produced by sintering a powder containing YSZ and combustible additives at a temperature sufficient to enable the YSZ to achieve partial densification in a solid state and to burn out the combustible additives. The porosity is provided by way of interconnected pores formed as a result of the combustion of the sintering additives; the target porosity of the ASL 16 is in the order of at least about 30%. After forming the porous YSZ ASL structure, the pores of the YSZ ASL are impregnated with nickel or a nickel compound as is known in the art. The impregnation is then followed by heat treatment steps as is known in the art. As the heat treatment steps are typically made in both oxidizing and reducing atmospheres, the impregnated nickel will typically be in both metallic (Ni) and oxide (NiO) form.

The impregnation process is carried out such that Ni/NiO is distributed thoroughly throughout the YSZ structure in a sufficient quantity (below 75% of the pore volume, and typically below 50% of the pore volume), that upon heat treatment, the Ni-phase is continuous through the inside of the YSZ porous structure. Such continuous distribution provides an electronic current path that enables the ASL 16 to serve as a current collector. This impregnation and heat treatment process may need to be repeated if the first application does not form a continuous Ni-phase. During impregnation a second phase such as YSZ, doped cerium oxide, alumina or its salts may be mixed with Ni-impregnation compound. One of the functions of this second phase materials is to reduce the grain growth of the Ni-metallic phase at the operating temperature. Generally grain-growth reduces the surface area and as a result the catalytic activity of the material reduces. After final heat treatment, Ni/NiO does not completely fill out the pore spaces since the pores need to remain open to provide reactant gas passage through the ASL 16.

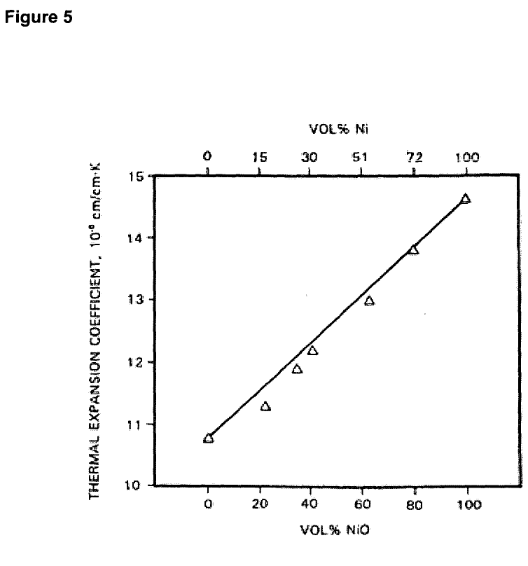

During operation, fuel is supplied to and permeates through the ASL 16 and is oxidized to produce electrons. Under certain circumstances, e.g. when an insufficient amount of fuel is supplied for the electrochemical reaction (“fuel starvation”), the nickel in the ASL 16 may oxidize, to form NiO. Since NiO has a different density than Ni, its formation will cause a volume change relative to Ni. However, since the Ni/NiO is impregnated inside a porous YSZ structure and since the expected volume change associated with the oxidation of Ni to NiO is less than the pore volume, it is expected that no or minimal change in the overall volume of the ASL 16 will occur as a result of Ni oxidation. Furthermore, the overall thermal expansion coefficient for the ASL 16 is expected to be reduced as a result of using Ni-impregnated YSZ instead of a traditional zirconia-nickel cermet. In a conventional anode-supported SOFC, the anode composition is a nickel-zirconia cermet having about 40 vol % Ni/NiO. Such a cermet has a thermal expansion coefficient of about 12.3×10⁻⁶ cm/(cm K) for 40% NiO cermet, and about 12.6×10⁻⁶ cm/(cm K) for a 40% Ni cermet (see FIG. 5, from S. Majumdar et al. J. Am. Ceram. Soc. 69 (1986) 628). In contrast, the present embodiment employs a nickel-free YSZ layer, which has a thermal expansion coefficient of about 10.6×10⁻⁶ cm/(cm K); therefore it is expected that volume changes as a result of heating and cooling will be less than in traditional nickel cermet anodes.

Since the volume changes resulting from Ni/NiO oxidation and thermal expansion/contraction in a Ni-impregnated ASL is expected to be less than in traditional cermet anodes, it is expected that the electrolyte layer 12 will experience less associated mechanical stress during operation, thereby reducing the occurrence of volume-change-induced cracking. An additional factor that is expected to contribute to the improved resistance to volume-change-induced cracking is the thinness of the AFL 14 relative to a traditional anode layer (AL) in a conventional anode-supported SOFC; the wall thickness of the AFL in this embodiment is expected to be in order of about 5 μm, whereas the wall thickness of traditional ALs are in the order of 1-2 mm. It is expected that the reduced thickness of the anode layer results in less volume change as a result of thermal expansion and other factors, in comparison to a thicker anode layer.

Alternatively, the ASL 16 can be produced by sintering a powder of Ni/NiO in the order of about 10-30 vol. % with the balance being YSZ. After the powder has been sintered to produce a solid state porous Ni-YSZ structure, the pores are impregnated with Ni/NiO.

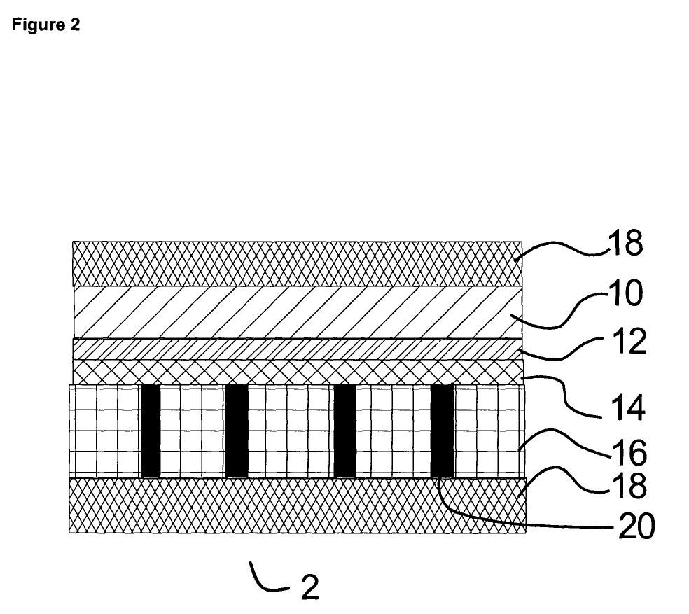

Referring to FIG. 2 and according to a second embodiment of the invention, the ASL 16 is provided with a plurality of vias 20 (channels) that span the thickness of the ASL 16, and provide a pathway for the flowthrough of reactant gas. The vias 20 may be created by one of the known methods in the art, e.g. by hole punching. The vias 20 are filled with electronically conductive materials e.g., Ag, Ag/Ni-alloy or any other silver alloys, Cu or Cu alloys, Ni or Ni alloys, tugsten and its alloy etc., to enable the ASL 16 to serve as a current collector. The rest of the ASL 16 structure may be substantially free of Ni or another electrically conductive material and if so, electric current conducts from the ASL 16 to the current collecting layer 18 mainly via the vias 20. Alternatively, the rest of the ASL 16 structure may be impregnated with Ni/NiO to assist in catalyzing and current conduction.

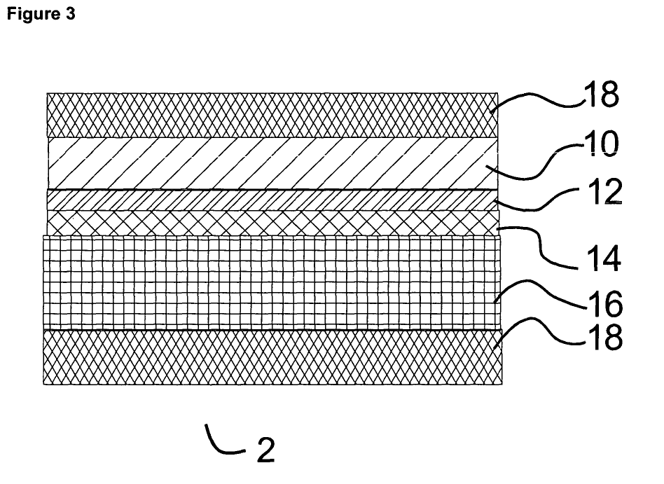

Referring to FIG. 3 and according to a third embodiment of the invention, the ASL 16 has a graded composition along its thickness. The surface of the ASL 16 facing the current collector 18 (“current collector side”) has the highest Ni content in the ASL 16, and the Ni content gradually reduces towards the surface of the ASL 16 facing the AFL 14. Therefore, layer 16 is compositionally-graded; the techniques for producing compositionally-graded materials are known in the art. To ensure electronic conductivity, Ni is gradually replaced by another electronically-conductive material towards the AFL side of the ASL 16, e.g. ferritic steel, a super alloy, or Ni—Ag alloy. This compositionally-graded ASL 16 is expected to have minimal volume changes as a result of oxidation-reduction, as ferritic steels and super alloys tend to exhibit less oxidation-related volume change than Ni or Ni/O. The Ni/NiO content is increased towards the ASL 16 for catalytic purposes.

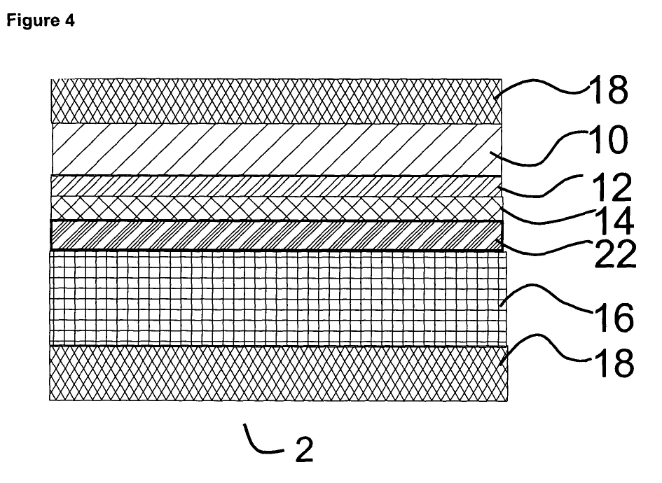

Referring to FIG. 4 and according to a fourth embodiment of the invention, a buffer layer 22 is introduced between the AFL 14 and the ASL 16. The buffer layer 22 is composed of a zirconia/nickel cermet and is highly porous (in the order of 40-90% porosity). The buffer layer 22 serves as a physical buffer between the ASL 16 and the other functional layers of the fuel cell, e.g. electrolyte layer 12. Due to its high porosity, the buffer layer 22 provides a greater degree of compliance than the other functional layers of the fuel cell, and thus is expected to minimize the amount of stress imposed on the electrolyte layer 12 as a result of volume changes in the ASL 16, thereby reducing or eliminating the occurrence of crack propagation in the electrolyte 12 or other functional layers of the fuel cell 2. The buffer layer 22 may be installed in any of the embodiments described above, e.g. in a fuel cell with a continuous Ni/NiO impregnated YSZ ASL 16, or a vias containing ASL 16, or a compositionally-graded ASL 16.

While the preferred embodiment of the invention has been illustrated and described, it will be appreciated that various changes can be made therein without departing from the scope and spirit of the invention.

1. An anode-supported solid oxide fuel cell comprising
(a) an anode support layer comprising a porous ion-conducting structure having pores impregnated with a catalytic and electronically conductive material;
(b) an electrolyte layer in adjacent intimate contact with the anode support layer; and
(c) a cathode layer in adjacent intimate contact with the electrolyte layer.

2. The fuel cell of claim 1 wherein the catalytic and electronically conductive material is selected from the group of nickel, copper, silver, tungsten, and any alloys of these materials.

3. The fuel cell of claim 2 further comprising a second phase material mixed with the catalytic and electronically conductive material, the second phase material being selected from the group of yttria-stabilized zirconia (YSZ), doped cerium oxide, alumina or its salts.

4. The fuel cell of claim 2 further comprising an anode functional layer between the anode support layer and the electrolyte layer such that the electrolyte layer is in adjacent intimate contact with the anode functional layer instead of the anode support layer.

5. The fuel cell of claim 4 wherein the porous ion-conducting structure of the anode support layer is substantially yttria-stabilized zirconia (YSZ).

6. The fuel cell of claim 5 wherein the catalytic and electronically conductive material is substantially evenly distributed throughout the anode support layer.

7. The fuel cell of claim 5 wherein the catalytic and electronically conductive material is Ni-containing material and is compositionally graded through the thickness of the anode support layer, with a higher concentration of the Ni-containing material at one major surface of the anode support layer than the other.

8. The fuel cell of claim 7 wherein the anode support layer further comprises a second conductive metal selected from the group of ferritic steel, super alloy, and Ni—Ag alloy and which is concentrated at the major surface of the anode support layer having the lower concentration of Ni-containing material.

9. The fuel cell of claim 4 further comprising a porous zirconia-nickel cermet buffer layer sandwiched in between the anode support layer and anode functional layer, and having a porosity between 40-90%.

10. The fuel cell of claim 4 wherein the composition of the porous ion conducting structure of the anode support layer is a mixture of 10-30 vol. % of Ni, or NiO or both, and the balance yttria-stabilized zirconia (YSZ).

11. The fuel cell of claim 4 wherein the anode support layer further comprises a plurality of vias extending through the thickness of the ion conducting structure of the anode support layer, at least some of the vias being filled with an electronically conducting material.

12. An anode-supported solid oxide fuel cell comprising
(a) an anode support layer comprising an ion conducting structure with a plurality of vias extending through the thickness of the ion-conducting structure, at least some of the vias being filled with electronically conductive material;
(b) an anode functional layer in adjacent intimate contact with the anode support layer;
(c) an electrolyte layer in adjacent intimate contact with the anode functional layer; and
(d) a cathode layer in adjacent intimate contact with the electrolyte layer.

13. An anode-supported solid oxide fuel cell comprising
(a) an anode support layer;
(b) a porous cermet buffer layer in adjacent intimate contact with the anode support layer, and being composed of a zirconia-nickel cermet with a porosity between 40 and 90%;
(c) an anode functional layer in adjacent intimate contact with the buffer layer;
(d) an electrolyte layer in adjacent intimate contact with the anode functional layer; and
(e) a cathode layer in adjacent intimate contact with the electrolyte layer.
